(19) United States
(12) Patent Application Publication
(10) Pub. No.: US 2015/0097782 A1
(43) Pub. Date: Apr. 9, 2015

(54) EMBEDDED TOUCHSCREEN STYLUS SECURED WITH SCREW MECHANISM

(71) Applicant: LAWRENCE LEE MOSES, Beverly Hills, CA (US)

(72) Inventor: LAWRENCE LEE MOSES, Beverly Hills, CA (US)

(21) Appl. No.: 14/045,214

(22) Filed: Oct. 3, 2013

(51) Int. Cl. G06F 3/0354; G06F 3/041

(52) U.S. Cl. CPC G06F 3/03545; G06F 3/0416; G06F 2200/1632
USPC 345/173

(57) ABSTRACT

An embedded touchscreen stylus secured with a screw mechanism is disclosed. The stylus fits into a receptacle in, for example, a mobile device or a case for a mobile device. The stylus includes a threaded neck that interfaces with a threaded opening of the receptacle. A head of the stylus protrudes from the receptacle, which may make it easier for users with large fingers or disabilities to retrieve and use the stylus.

### BACKGROUND

The embodiments herein relate generally to touchscreen styluses that are embedded in a device.

Touchscreen devices are increasingly common. While many users interact a touchscreen by using a finger as a pointing device, many users prefer to user a stylus to interact with a touchscreen. Many solutions are currently available for storing a stylus with a touchscreen device. However, the current solutions all suffer from one or more drawbacks. For example, many solutions rely on a spring-loaded or spring-activated mechanism to pop the stylus out of the device or case and to retain the stylus when not in use. Accidental contact can cause the stylus to eject and become lost. Frequent use can result in failure of the spring or retaining tabs, rendering the solution useless. Other mechanisms rely on friction between the stylus and its receptacle. These are also prone to accidental release of the stylus. In addition, these mechanisms are poorly suited to users with large fingers or disabilities, who may have trouble removing the stylus from its holder.

### SUMMARY

According to one embodiment of the present invention, a stylus storage system for a touchscreen device improves retention and accessibility of the stylus. The system includes a receptacle for a touchscreen stylus and a stylus configured for use with a touchscreen. The receptacle is configured to be associated with a mobile device. The stylus includes a cylindrical body with a first end and a second end, a point configured to interact with a touchscreen and located at the first end of the body, a head located at the second end of the body, and a threaded neck located between the head and the body. The receptacle includes a slot configured to receive at least the point and the body of the stylus. The receptacle also includes a threaded opening configured to interface with the threaded neck of the stylus to removably retain the stylus in the receptacle. The head of the stylus is configured to protrude from the threaded opening of the receptacle when the threaded neck is engaged with the threaded opening.

Additionally, the receptacle may be integrated into a mobile device or a case for a mobile device. The head of the stylus may be configured to protrude from the threaded opening of the receptacle when the threaded neck is fully engaged with the threaded opening. For example, the head of the stylus may be configured to protrude from substantially 0.4 inches to substantially 0.6 inches from the threaded opening of the receptacle when the threaded neck is fully engaged with the threaded opening. The head of the stylus may include one or more gripping ridges configured to make gripping and/or twisting the head easier.

### BRIEF DESCRIPTION OF THE FIGURES

The detailed description of some embodiments of the present invention is made below with reference to the accompanying figures, wherein like numerals represent corresponding parts of the figures.

FIG. 1 shows a perspective view of one embodiment of the present invention, with a stylus inserted into a mobile device.

FIG. 2 shows a exploded perspective view of the embodiment of FIG. 1, us removed from a mobile device.

FIG. 3 shows a cutaway plan view of the embodiment of FIG. 1, with a stylus inserted into a mobile device.

FIG. 4 shows a detail cutaway view of the embodiment of FIG. 1, with a stylus inserted into a mobile device.

### DETAILED DESCRIPTION OF CERTAIN EMBODIMENTS

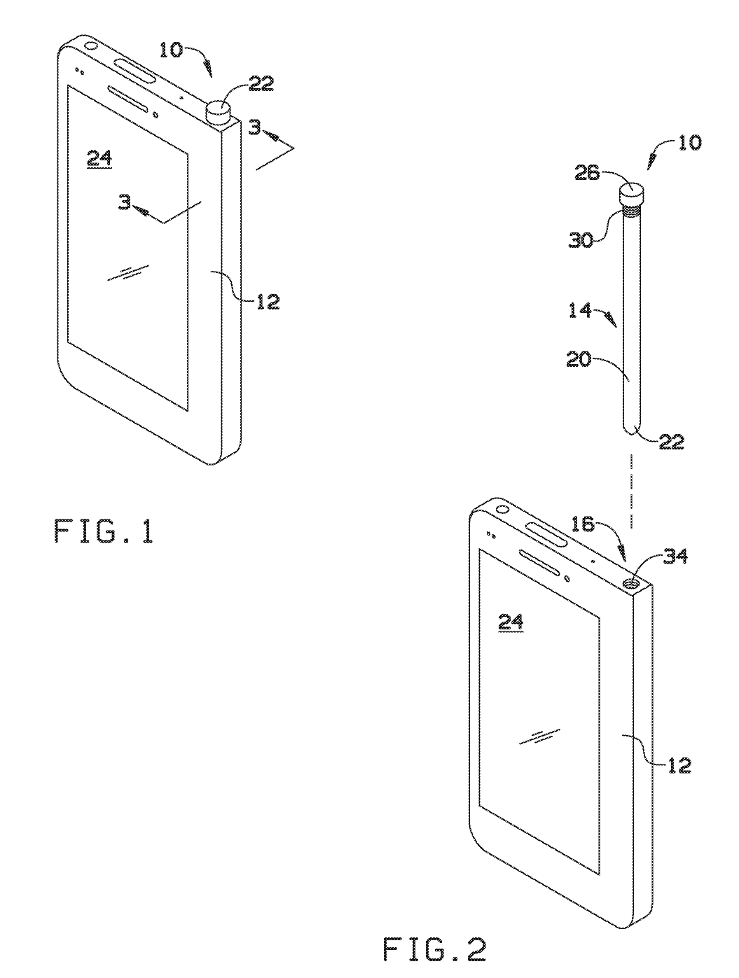

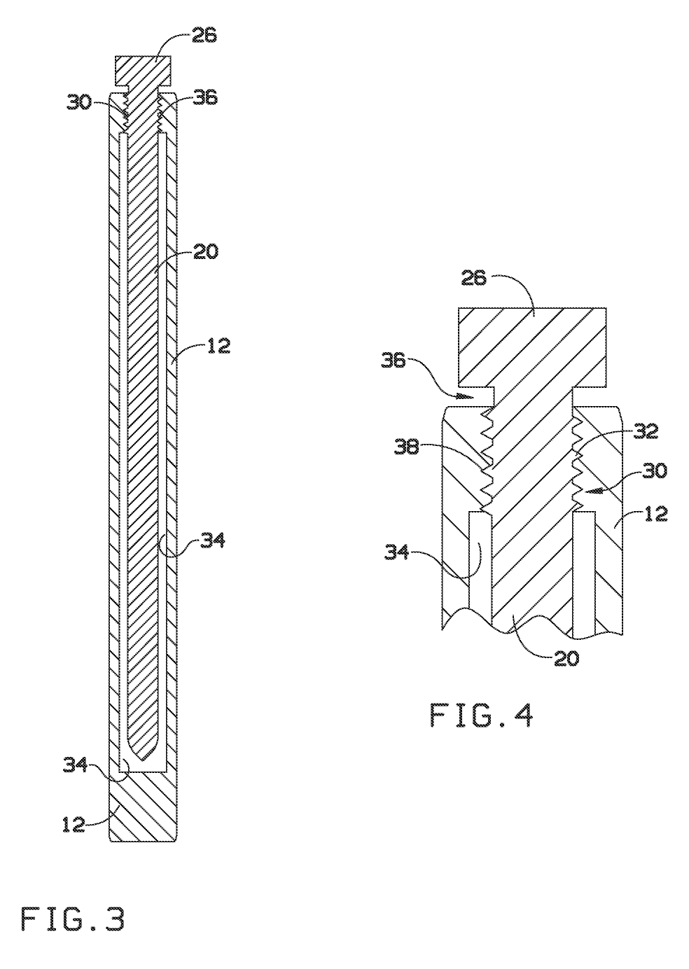

By way of example, and referring to FIGS. 1-4, one embodiment of the present invention comprises a stylus storage system 10 for a touchscreen device 12. The system 10 may include a stylus 14 and a receptacle 16 associated with the device 12. The stylus 14 may include a body 20, which may be substantially cylindrical. The body 20 may include a substantially smooth surface, or it may include a textured surface to improve grip, handling, and so on. The stylus 14 may include a point 22 at one end of the body 20. The point 22 may include a surface or material so that the point 22 can interact with a touchscreen 24 on the device 12 in the same way that a user's finger would interact with the touchscreen 24. The stylus may include a head 26, which may he located at the opposite end of the cylindrical body 20 from the point 22. The head 26 may include a cylindrical shape, similar to the body 20, but the head 26 may include a larger radius than the body 20. The head 26 may include a textured surface, which may make gripping the head 26 easier. The head 26 may include a contoured shape or another shape that may make gripping the head 26 easier. The head 26 may include one or more gripping ridges, which may make gripping and/or twisting the head 26 easier. A threaded neck 30 may be located between the head 2.6 and the body 20, and the neck 20 may include one or more male threads 32.

The receptacle 16 may include a slot 34 and a threaded opening 36, which may include one or more female threads 38. In use, the stylus may be inserted, point 22 first, into the receptacle 16 through the threaded opening 36 until the point 22 and the body 20 are within the slot 34. The male threads 32 of the threaded neck 20 of the stylus 14 may interface with the female threads 38 of the opening 36. When the male threads 32 and female threads 34 have interfaced, the threaded neck 30 may be regarded as engaged with the threaded opening 36. Twisting the stylus 14 relative to the receptacle 16 may pull or auger the stylus 14 into the receptacle 16. The receptacle 16 and/or the stylus 14 may include a stop or other mechanism (not shown) to limit how far the stylus 14 may be twisted into the receptacle 16. Once the stop has been reached, the threaded neck 20 may be regarded as fully engaged with the threaded opening 36. The slot 34 may have sufficient dimensions to accommodate the body 20 and point 22 of the stylus 14, for example, when the threaded neck 20 is filly engaged with the threaded opening 36.

Additionally, when the threaded neck 20 is fully engaged with the threaded opening 36, the head 26 of the stylus may protrude our or above the opening 36. For example, the head 26 may protrude approximately 0.5 inches, with a tolerance of approximately 0.1 inches. Other sizes are contemplated. This protrusion, combined with the shape and/or radius of the head 26, may make the head easier to grip for a person with larger hands and fingers; who suffers from, e.g., multiple sclerosis, Parkinson's Disease, or another condition; or who simply prefers a more accessible stylus 14.

The threaded retention mechanism of the opening 36 and neck 30 may retain the stylus 16 better than other mechanisms, including those that rely on a spring-loaded mechanism or on friction between the stylus and the receptacle. The threaded retention mechanism may resist wear better or last longer than other mechanisms, including, e.g., spring-activated and/or spring-loaded mechanisms. Furthermore, if a part wears out to the point of no longer functioning in an acceptable way, it is easy to replace a part of the present invention. For example, if the threads 32 of the neck 30 wear down and are no longer able to retain the stylus 14 in the receptacle 16, this problem may be remedied by replacing the stylus 14. In contrast, if the spring of a spring-activated mechanism wears out, or if a retaining tab of such a mechanism breaks off, the mechanism is not easily repaired without replacing the entire mechanism.

While the foregoing description and accompanying drawings show the system 10 as integrated into a mobile device 12, those skilled in the art will appreciate that the system 10 may be offered as an after-market solution. For example, a case (not shown) for a mobile device 12 may integrate the system 10.

Persons of ordinary skill in the art may appreciate that numerous design configurations may be possible to enjoy the functional benefits of the inventive systems. Thus, given the wide variety of configurations and arrangements of embodiments of the present invention the scope of the present invention is reflected by the breadth of the claims below rather than narrowed by the embodiments described above.

What is claimed is:

1. A stylus storage system for a touchscreen device, which improves retention and accessibility of the stylus, the system comprising:
a receptacle for a touchscreen stylus, the receptacle configured to be associated with a mobile device;
a stylus configured for use with a touchscreen and comprising a cylindrical body comprising a first end and a second end, a point configured to interact with a touchscreen and located at the first end of the body, a head located at the second end of the body, and a threaded neck located between the head and the body;
wherein the receptacle comprises a slot configured to receive at least the point and the body of the stylus and a threaded opening configured to interface with the threaded neck of the stylus to removably retain the stylus in the receptacle;
further wherein the head of the stylus is configured to protrude from the threaded opening of the receptacle when the threaded neck is engaged with the threaded opening.

2. The system of claim 1, wherein the receptacle is integrated into a mobile device.

3. The system of claim 1, wherein the receptacle is integrated into a case for a mobile device.

4. The system of claim 1, wherein the head of the stylus is configured to protrude from the threaded opening of the receptacle when the threaded neck is fully engaged with the threaded opening.

5. The system of claim 4, wherein the head of the stylus is configured to protrude from substantially 0.4 inches to substantially 0.6 inches from the threaded opening of the receptacle when the threaded neck is fully engaged with the threaded opening.

6. The system of claim 4, wherein the head of the stylus comprises at least one gripping ridge configured to make at least one of gripping the head and twisting the head easier.
